(19) United States
(12) Patent Application Publication
(10) Pub. No.: US 2015/0149334 A1
(43) Pub. Date: May 28, 2015

(54) Transfer Pricing Systems and Methods

(71) Applicant: Thomson Reuters (Tax & Accounting) Services Inc., Carrollton, TX (US)

(72) Inventors: Brian Tully, Hoboken, NJ (US); Pablo Perez Perez, Hoboken, NJ (US); Carl Philip Brandt, Ridgewood, NJ (US); Enrico Valendiano Galvez, Valley Stream, NY (US); Vikram Purohit, Balaghat (IN)

(73) Assignee: Thomson Reuters (Tax & Accounting) Services Inc., Carrollton, TX (US)

(21) Appl. No.: 14/089,933

(22) Filed: Nov. 26, 2013

(51) Int. Cl. G06Q 40/00

(52) U.S. Cl. CPC G06Q 40/12; G06Q 40/123
USPC 705/31; 705/30

(57) ABSTRACT

A method includes identifying a plurality of functions performed by at least one of a sales division of an entity, a manufacturing division of the entity, or a supplier division of the entity during an intra-entity transaction by the at least one division. The method also includes determining, for each function of the plurality of functions, an allocation relationship based on an operating parameter of the at least one division, and determining, for each function, an intra-entity sales expense using the respective allocation relationship associated with each function. The method further includes providing, to the entity, an indication of net income and target earnings for the at least one division. The net income is provided for each function, and is determined based on the respective intra-entity sales expense associated with each function.

### COPYRIGHT NOTIFICATION

Portions of this patent application include materials that are subject to copyright protection. The copyright owner has no objection to the facsimile reproduction by anyone of the patent document itself, or of the patent application as it appears in the files of the United States Patent and Trademark Office, but otherwise reserves all copyright rights whatsoever in such included copyrighted materials.

### TECHNICAL FIELD

The techniques presented herein relate to providing accounting-related services, and more particularly, to robust computer-implemented, computer-assisted, and computer-integrated tools, resources, and processes for transfer pricing analysis associated with intra-entity transactions.

### BACKGROUND

A “transfer price” measures the value of products (i.e., goods or services) transferred from a first division within a company, corporation, partnership, or other legal entity to a second division within the same entity. Such a transfer is typically referred to as an “intra-entity transaction,” and the associated transfer price is in contrast with, for example, a market price, which measures exchanges between an entity and its outside customers. It is understood that such intra-entity transactions could include sales, loans, licenses, and/or any other like transactions typically associated with such entities. As part of transferring a product from a first division within the entity to a second division, the transfer price assigned to the product can result in revenue for the first division (the division transferring the product) and cost for the second division (the division receiving or purchasing the product). According to generally accepted accounting principles (“GAAP”), an appropriate transfer price can be assigned in a number of ways. For example, if a market price for the product exists, a market-based transfer price is generally assigned to the product. On the other hand, in situations in which no reliable market price exists for use as a basis for the transfer price, a cost-based transfer price can be used.

Regardless of how the transfer price is determined, local, national, and/or international governments require that the entity be able to adequately justify the assigned transfer price using GAAP. Such justification is typically embodied in the preparation of lengthy accounting reports setting forth the various costs associated with the transferred product, examples of analogous transfer prices assigned to similar products, and the like.

Recently, however, governments have placed increased scrutiny on such transfer pricing techniques in order to avoid abuse by multinational entities. While such entities typically keep accurate records of assets, liabilities, net sales, net income (i.e., actual earnings), retained earnings, and other metrics typically associated with standard financial statements, such metrics are typically not adequate for documenting and justifying transfer prices associated with intra-entity transactions.

This task is particularly cumbersome and complex for relatively large entities given the nature and breadth of their commercial enterprises. For example, such entities typically have sales divisions, manufacturing divisions, supplier divisions, and/or other like divisions in multiple states, countries, or other like jurisdictions. As a result, such intra-entity transactions may be subject to a wide array of complex and ever-changing tax laws and regulations. Despite these difficulties, it is imperative for such entities to accurately account for the transfer prices associated with intra-entity sales when determining net income and other like accounting metrics in order to avoid underpayment of taxes, as well as other penalties levied by the relevant government authorities.

### SUMMARY

In an example embodiment of the present disclosure, a method includes identifying a plurality of functions performed by at least one of a sales division of an entity, a manufacturing division of the entity, or a supplier division of the entity during an intra-entity transaction by the at least one division. The method also includes determining, for each function of the plurality of functions, an allocation relationship based on an operating parameter of the at least one division, and determining, for each function, an intra-entity sales expense using the respective allocation relationship associated with each function. The method further includes providing, to the entity, an indication of net income and target earnings for the at least one division. The net income is provided for each function, and is determined based on the respective intra-entity sales expense associated with each function.

In another example embodiment, a system includes one or more processors, and an input device in communication with the one or more processors and configured to receive information indicative of a sales division of an entity, a manufacturing division of the entity, and a supplier division of the entity. The system also includes at least one of a calculation engine, a mapping engine, and an allocation engine in communication with the one or more processors. When executed by the one or more processors, the at least one engine performs operations including identifying a plurality of functions performed by at least one of the sales division, the manufacturing division, or the supplier division during an intra-entity transaction by the at least one division. The operations also include determining, for each function of the plurality of functions, an allocation relationship based on an operating parameter of the at least one division. The operations further include determining, for each function, an intra-entity sales expense using the respective allocation relationship associated with each function.

This Summary introduces a selection of concepts in a simplified form that are further described below in the Detailed Description. This Summary is not intended to identify key or essential features of the claimed subject matter; it is not to be used for determining or limiting the scope of the claimed subject matter.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an overview of one or more systems configured to determine the net income (i.e., the actual earnings) of an entity based at least in part on transfer prices associated with functions performed by one or more divisions of the entity.

FIG. 2 illustrates example information utilized in calculating the net income of an entity, and an example supply chain map associated with such calculations.

FIG. 3 illustrates a component level view of a computing device configured with engines associated with calculating the net income of an entity based at least in part on transfer prices.

FIG. 4 illustrates an example process for calculating the net income of an entity based at least in part on transfer prices, and generating a report indicative of the net income and target earnings.

### DETAILED DESCRIPTION

In the following description, various aspects of exemplary embodiments of the subject matter defined in the appended claims are described. For purposes of explanation and understanding, specific configurations and details are set forth in order to provide a thorough understanding of this claimed subject matter, and well-known and/or understood features may be omitted or simplified in order not to obscure this understanding. Furthermore, it will also be appreciated that the embodiments set forth herein may be practiced without the specific details presented. It will also be understood that these exemplary embodiments are not intended to be limiting, and those possessing ordinary skill in the art and having access to the teachings herein will recognize additional implementations, modifications, and embodiments, as well as other applications, which are fully contemplated herein as within the scope of what is disclosed and claimed herein.

### Overview

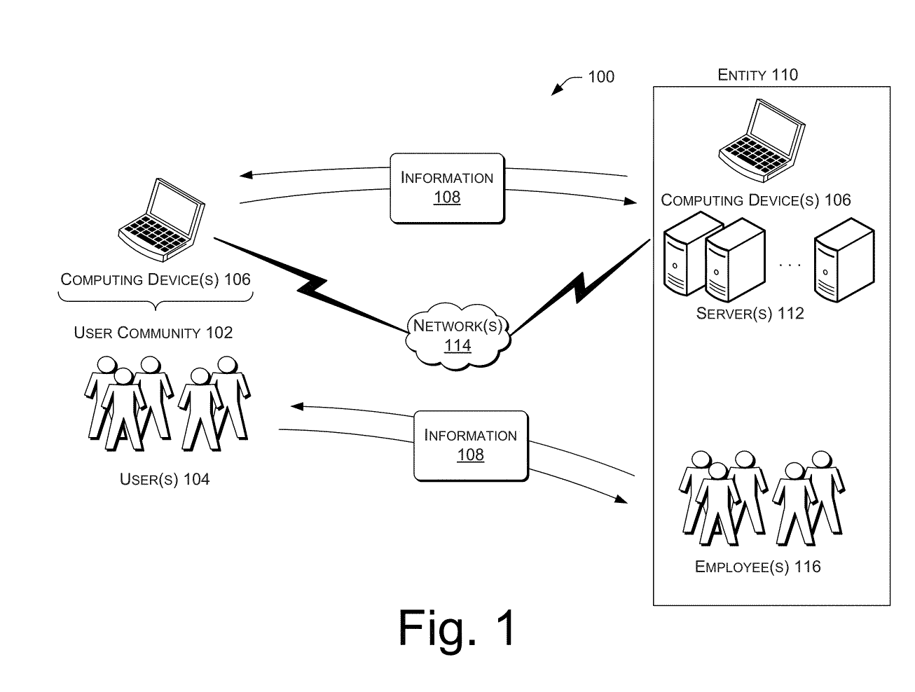

FIG. 1 illustrates an overview of an example architecture and/or system 100 configured to estimate, calculate, and/or otherwise determine the net income (i.e., actual earnings) of an entity, on a function-by-function basis, based at least in part on transfer pricing information associated with intra-entity transactions. In the illustrated example, a user community 102 comprising one or more users 104 may employ one or more computing devices 106 of the system 100 to determine net income. In particular, the users 104 may collect a wide array of information 108 from multiple sources within and/or associated with a particular entity 110. For example, information 108 may be gathered from sources including one or more databases, reports, files, and/or other like records maintained by the entity 110. Such sources of information 108 may be stored electronically in a variety of different locations within the entity 110. For example, such sources of information 108 may be stored on one or more computing devices 106 of the entity 110 and/or one or more servers 112 of the entity 110. The computing devices 106 employed by the users 104 to gather such information 108 may be in communication with the servers 112 and/or the computing devices 106 of the entity 110 via one or more networks 114. Additionally, such sources of information 108 may include human persons or employee(s) 116 of the entity 110, and information 108 may be gathered by the users 104 via in-person communication with such employees 116.

The entity 110 may be a legal entity, such as a corporation, a company, a partnership, etc. Further, the entity 110 may include one or more divisions and/or subdivisions. For example, as will be described below, an example entity 110 may include a sales division, a manufacturing division, a supplier division, and/or other like divisions. Such divisions may be located in a single state, country, or other like jurisdiction. Alternatively, such divisions may be located in multiple jurisdictions in order to best fulfill the needs, functions, and/or operations of the entity 110.

The users 104 may be financial consultants or advisers enlisted by the entity 110 to generate, revise, and/or finalize various financial reports indicative of the profits and losses associated with the functions of the divisions of the entity 110. In particular, as will be described below, such reports may identify the net income of the various divisions of the entity 110, and the net income may be determined based on the respective intra-entity sales expenses associated with the functions performed by the division. Such users 104 may also train employees 116 of the entity 110 to generate such reports. Thus, over time, the users 104 of the systems 100 described herein may comprise employees 116 of the entity 110. Alternatively and/or additionally, the users 104 may certify additional accounting firms, consultants, advisers, and/or other third-party implementers to generate such reports for the entity 110. In such an example, over time, the users 104 may comprise such certified third-party implementers.

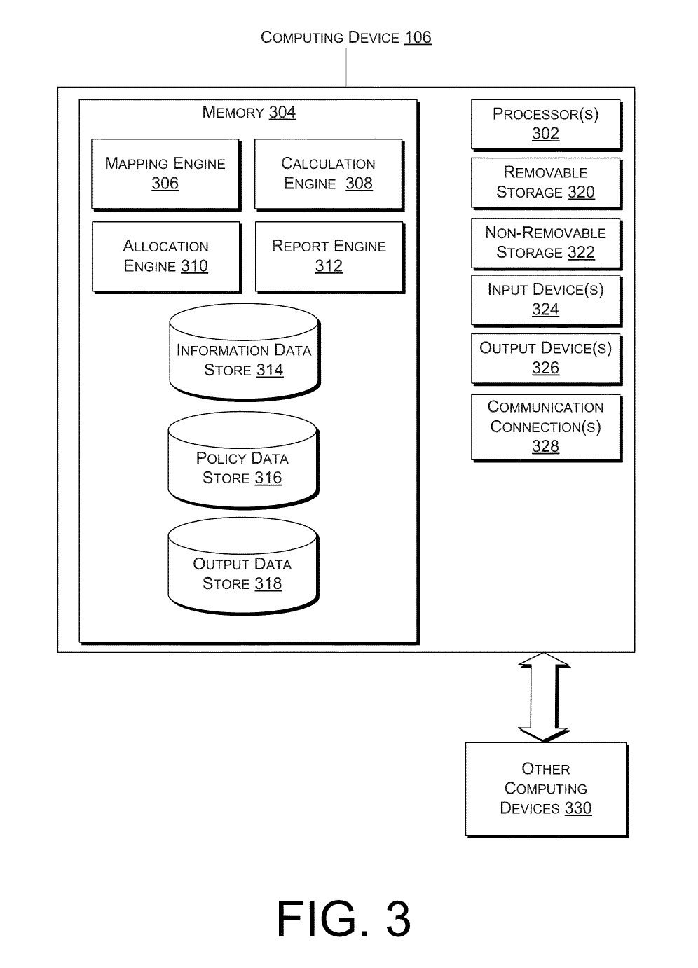

The computing devices 106 described herein may be a server or server farm, multiple, distributed server farms, a mainframe, a work station, a personal computer (PC), a laptop computer, a tablet computer, a personal digital assistant (PDA), a mobile phone or other wireless device, a media center, an embedded system, or any other sort of device or devices. Additionally, the servers 112 of the present disclosure may include one or more mainframes and/or one or more computing devices 106 of the type described herein. In some implementations, the computing devices 106 represent a plurality of computing devices working in communication, such as a cloud computing network. In further implementations, one or more of the computing devices 106 represents one or more virtual machines. An example computing device capable of serving as a computing device 106 is illustrated in FIG. 3 and described below with reference to that figure.

When the one or more computing devices 106 and/or servers 112 includes multiple, networked computing devices, those computing devices may be connected by any one or more wired networks 114, wireless networks 114, or any combination thereof. Further, such networks 114 may include any one or combination of multiple different types of public or private networks (e.g., wide access networks (WANs), local access networks (LANs), the Internet, etc.). In some instances, computing devices 106 and/or servers 112 communicate over the networks 114 using a secure protocol (e.g., https) and/or any other protocol or set of protocols, such as the transmission control protocol/Internet protocol (TCP/IP).

As noted above, the users 104 may gather information 108 from various sources associated with the entity 110. For example, the users 104 may gather information 108 through directly interfacing with the computing devices 106 and/or the servers 112 of the entity 110. Such a direct interface may include, for example, the users 104 visiting the entity 110 and physically copying, downloading, and/or otherwise gathering information 108 from the various sources within the entity 110. Additionally and/or alternatively, the users 104 may gather information 108 from the computing devices 106 and/or the servers 112 of the entity 110 by connecting and/or otherwise communicating with such computing devices 106 and/or servers 110 via the one or more networks 114. Such a network communication may, for example, enable gathering the information 108 via file transfer protocol and/or other like means. The users 104 may also gather such information 108 via in-person communication with one or more employees 116 of the entity 110. Such in-person communication may occur face-to-face, via telephone, via Skype, via email, and/or via any other known communication method.

As described herein, the information 108 may include any type of categories, data, metadata, analysis, and/or other like items useful in performing financial analysis on the entity 110. For example, such information 108 may include the various assets, liabilities, cash, securities, accounts receivable, inventory, prepaid expenses, property, plant & equipment, investments, intellectual property, goodwill, accounts payable, bank loans, accrued liabilities, estimated tax liability, long term debt, deferred income tax, owner's equity, common stock, paid-in capital, retained earnings, net sales, cost of sales, gross margin, research and development expense, sales expense, operating income, revenue, interest expense, royalties, net income, earnings per share of common stock, retained earnings, depreciation, cash flow, and/or other like categories typically shown financial statements prepared in accordance with GAAP. Such information 108 may also include the products, manufacturing divisions, supplier divisions, sales divisions, distribution divisions, management divisions, or other divisions of the entity 110, the states, countries, or other jurisdictions in which such divisions are located, the currency in such jurisdictions, the various exchange rates associated with such currencies, the headcount at each division of the entity 110, and other like categories. The information 108 may also include any of the values, quantifications, or other data associated with such categories.

The information 108 described herein may also include income tax data, state apportionment data, tax provision data, historical income data, tax laws, and tax or business requirements of the various jurisdictions in which the entity 110 has a division. Such tax information may include at least one of federal tax laws, state tax laws, tax formulas, tax calculation flows, tax rates, modification rates, graduated rates, payment options, tax adjustment options, tax credit options, calculating options, rounding options, filing methods, or tax forms. It is understood that the information 108 may be classified as being financial information, operational information, tax information, and/or any other type of information typically associated with entities 110 of the types described herein. Further, such information 108 may include rules, policies, earnings targets, intra-entity agreements, product codes, profit centers, cost centers, level entity codes, hierarchies, organization charts, material codes, SKU numbers, trading partners, customers, and/or any other entity-specific information characteristic of the various supply chains, business practices, and/or other organizational operations of the entity 110.

The sources of such information may include balance sheets, income statements, cash flow statements, acquisition and consolidation statements, quarterly reports, annual reports, tax filings, and/or other financial statements (collectively “trial balances”) typically prepared by and/or associated with the entity 110. The sources of such information 108 may also include various charts, graphs, files, documents, emails, databases, spreadsheets, business records, and/or other like items typically produced or retained by the entity 110. Additionally, as noted above, the users 104 may interface with employees 116 of the entity 110 to obtain such information 108, and in such situations, the employees 116 may comprise sources of the information 108. It is understood that in some situations, the information 108 may be already be organized into, for example, the various categories described herein. In further situations, on the other hand, the uses 104 may synthesize, sort, group, correlate, and/or otherwise categorize the information 108 during or after collection thereof. In such situations, the various categories described herein may be generated by the users 104 based on, for example, the operating characteristics of the entity 110.

In an example embodiment, the information 108 may be entered by a user 104 through a user interface or other like input device associated with the computing devices 106 or may be received from another source, such as a financial platform. Such financial platforms may include, for example, the Thomson Reuters ONESOURCE® tax accounting platform, and such platforms may provide the users 104 with automated processes that enable more accurate and efficient compliance with global tax regulations. The above example information 108 and example sources of information 108 are described simply for illustrative purposes, and any number of alternative information and/or sources of information may be utilized by the users 104 and/or the system 100.

### Example Information and Supply Chain Map

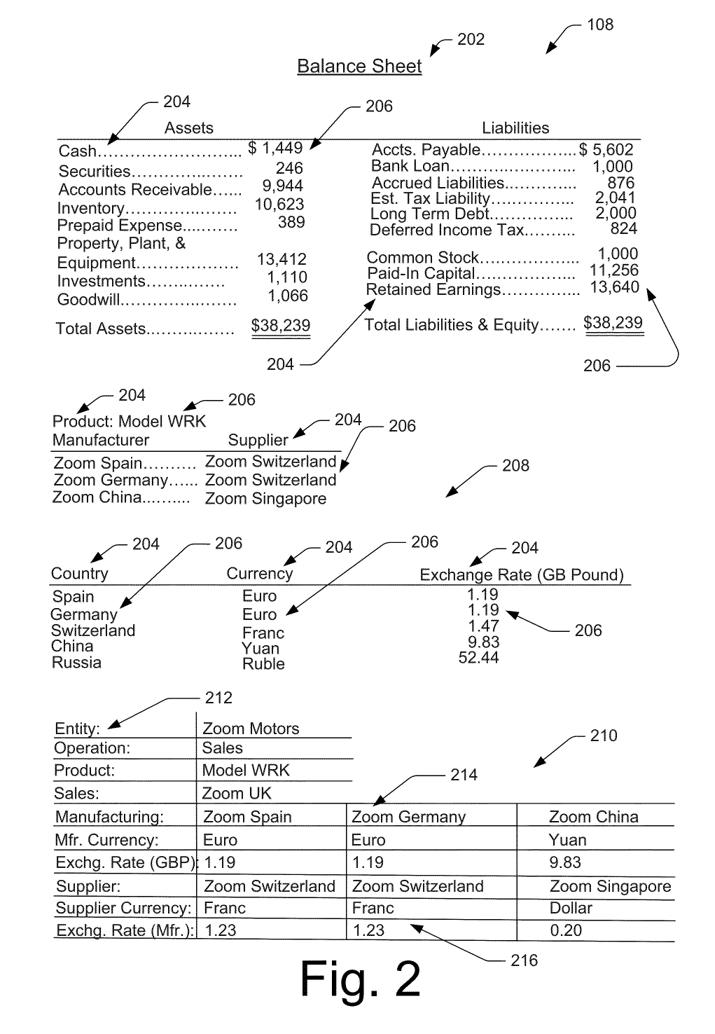

FIG. 2 illustrates example information utilized in calculating the net income of an entity, and an example supply chain map associated with such calculations. For the remainder of this disclosure, reference shall be made to an example entity 110 named “Zoom Motors,” and the various information shown in FIG. 2 may be indicative of and/or otherwise characteristic of one or more divisions, functions, and/or operations of Zoom Motors. It is understood, however, that such details are merely exemplary, and that the present disclosure is not limited to the information 108 shown in FIG. 2.

The information 108 illustrated in FIG. 2 includes financial information 202 associated with Zoom Motors, and in particular, FIG. 2 illustrates a portion of an example Zoom Motors balance sheet. The balance sheet includes a plurality of categories 204 associated with the various assets and liabilities of Zoom Motors. For example, such categories 204 include cash, securities, accounts receivable, inventory, accounts payable, retained earnings, and other like metrics typically used in financial reporting and in accordance with GAAP. Such information 108 also includes the values and/or data entries 206 associated with, and in some instances quantifying, each respective category 204. It is understood that while an example balance sheet is shown in FIG. 2, in further embodiments, such information 108 associated with Zoom Motors may also include the various categories 204 and data entries 206 included in an income statement, a cash flow statement, or other like financial statement (i.e., trial balance) prepared in accordance with GAAP.

The information 108 illustrated in FIG. 2 also includes various operating information 208 associated with Zoom Motors. As described above with respect to the financial information 202, such operating information 208 may also include various categories 204 and data entries 206 associated with, and in some instances quantifying, each respective category 204. For example, such operating information 208 may include various products, manufacturing divisions, supplier divisions, countries, currencies, exchange rates, target earnings (i.e., target profit levels), headcount, entity policies, and/or any of the other categories 204 described herein. Likewise, the data entries 206 associated with such operating information 208 may quantify and/or characterize the attributes of Zoom Motors corresponding to such categories 204. For example, as shown in FIG. 2, a first set of example operating information 208 may include a chart, table, file, or other like report identifying categories 204 comprising a product, manufacturing division, and/or supplier division of Zoom Motors. In the illustrated example, such manufacturing divisions may include Zoom Spain, Zoom Germany, and Zoom China, while such supplier divisions may include Zoom Switzerland and Zoom Singapore. As shown in FIG. 2, a second set of example operating information 208 may include a chart, table, file, or other like report identifying categories 204 including a country, a corresponding currency, and an exchange rate associated with the currency. In the illustrated example, the data 206 and such a report may include the actual countries in which various divisions of Zoom Motors are located, the currency used in each country, and the exchange rate utilized to convert each respective currency into a second currency (e.g., English pounds). As noted above, the financial information 202 and operating information 208 shown in FIG. 2 is merely exemplary, and in further embodiments, the information 108 may include more than, less than, or different information than that shown in FIG. 2.

In example methods of the present disclosure, the system 100 may be employed to generate a variety of different reports based on the information 108 collected. In some embodiments, such methods may be carried out fully-automatically by the various computing devices 106 and/or other components of the system 100, while in other embodiments, such methods may be carried out at least partially manually by one or more users 104. In generating such reports, the gathered information 108 may be analyzed and/or otherwise utilized to identify one or more divisions of the entity 110. The information 108 may also be analyzed in order to identify one or more functions performed by the respective divisions of the entity 110. As a result, the various reports generated by the system 100 may provide, for each division, the net income associated with each respective function performed by the division. While existing accounting tools may be capable of calculating profits and losses for entities as a whole, and even for various divisions of such entities, existing tools are not configured to determine the net income generated by the various divisions of the entity on a function-by-function basis. Further, since the various transfer prices associated with intra-entity transactions by such divisions play a significant role in determining the net income of the various divisions, such existing accounting tools are not capable of accurately accounting for such transfer prices.

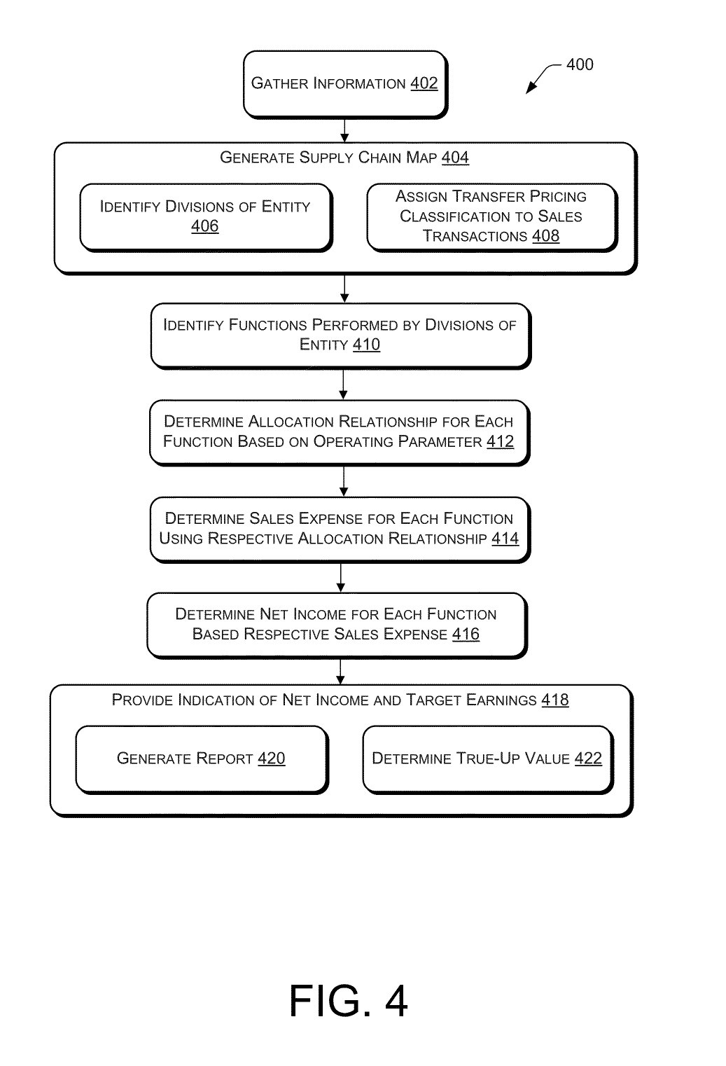

In an example embodiment, the system 100 may be utilized to generate one or more supply chain maps. In such an embodiment, the various divisions of the entity 110, and the functions performed by each division, may be identified during the process of generating such a supply chain map. Additionally, a transfer pricing classification may be assigned to one or more intra-entity transactions performed by the various divisions during the process of generating the supply chain map. The process of generating such a supply chain map will be described in greater detail below with respect to FIG. 4, and an example supply chain map 210 is illustrated in FIG. 2.

As shown in FIG. 2, an example supply chain map 210 may include information including any of the various categories 204 and/or data entries 206 described above. In particular, the various categories 212 of the supply chain map 210 may include one or more of the categories 204 described above, and the various data entries 214, 216 of the supply chain map 210 may include one or more of the data entries 206 described above. In further embodiments, one or more of the data entries 214, 216 of the supply chain map 210 may comprise one or more of the categories 204. In such embodiments, the supply chain map 210 may be configured such that the data entries 214, 216 illustrated therein correlate with the identified divisions of the entity 110 to the extent possible. For example, the supply chain map 210 shown in FIG. 2 indicates that the sales division of Zoom Motors is located in England, and that the manufacturing divisions of Zoom Motors include Zoom Spain, Zoom Germany, and Zoom China. The supply chain map 210 also indicates the respective currencies and corresponding exchange rates associated with converting currency of the manufacturing division country to that of the sales division country (GBP). It is understood that such exchange rates and currencies may be utilized in intra-entity transactions between the manufacturing division and the sales division. For example, in an intra-entity transaction in which Zoom Spain sells a product to Zoom UK, a corresponding transfer price in euros may be converted to English pounds at an exchange rate of 1.19.

Additionally, the supply chain map 210 indicates that Zoom Switzerland is the supplier division associated with Zoom Spain and Zoom Germany while Zoom Singapore is the supplier division associated with Zoom China. The supply chain map 210 also indicates the currency associated with the country of each respective supplier division, as well as the corresponding exchange rates associated with converting currency of the supplier division country to currency of the respective manufacturing division country. It is understood that such exchange rates and currencies may be utilized in intra-entity transactions between the supplier division and the manufacturing division. For example, in an intra-entity transaction in which Zoom Switzerland sells a product to Zoom Spain, a corresponding transfer price in Swiss francs may be converted to euros at an exchange rate of 1.23.

Such a supply chain map 210 may be generated in accordance with various business trends, entity norms, internal policies, and/or other organizational rules associated with the entity 110, and such rules may be learned, observed, and/or otherwise gathered when the information 108 described herein is collected. For example, such rules may indicate that all products manufactured by divisions of the entity 110 located in Europe may be received from the Zoom Switzerland supplier division. Accordingly, such an organizational rule may be reflected in the resulting supply chain map 210. Such rules may comprise respective transfer pricing classifications associated with intra-entity transactions between divisions of the entity 110.

In an example embodiment, such transfer pricing classifications may also include an indication of a currency associated with the transaction and/or an exchange rate associated with the transaction. It is understood that a first transfer pricing classification may be assigned to intra-entity transactions between, for example, the supplier division and the manufacturing division of the entity 110. Likewise, a second transfer pricing classification, potentially different than the first transfer pricing classification, may be assigned to intra-entity transactions between the manufacturing division and the sales division of the entity 110. For example, when purchasing a product from Zoom Switzerland, Zoom Spain may convert the transfer price of the product from Swiss francs to euros at the exchange rate identified in the supply chain map 210. Likewise, when purchasing a product from Zoom Spain, Zoom UK may convert the transfer price of the product from euros to English pounds at the respective conversion rate identified in the supply chain map 210. Further, since the supply chain map 210 may be organized and/or categorized based on the various functions performed by each division of the entity 110, intra-entity sales expenses, net income, and/or other metrics may be determined, for each respective function, based on the one or more transfer pricing classifications included in the supply chain map 210.

### Example Device

FIG. 3 illustrates example details of the computing devices 106 shown in FIG. 1. As noted above, the computing devices 106 may assist users 104 in preparing reports providing an indication of net income, target earnings, and/or other financial metrics to the entity 110, on a function-by-function basis (i.e., for each respective function performed by the division). In some instances, one or more computing devices 106 may be equipped with one or more processors 302, memory 304 communicatively coupled to the one or more processors 302, and one or more additional components commonly associated with computing devices 106 of the type described herein. The one or more processors 302 may include a central processing unit (CPU), a graphics processing unit (GPU), a microprocessor, a digital signal processor, and so on.

The memory 304 may include software and/or firmware functionality configured as one or more modules or “engines.” The term “engine” is intended to represent example divisions of the software and/or firmware for purposes of discussion, and is not intended to represent any type of requirement or required method, manner or necessary organization. Accordingly, while various “engines” are discussed, their functionality and/or similar functionality could be arranged differently (e.g., combined into a fewer number of engines, broken into a larger number of engines, etc.). As illustrated in FIG. 3, the memory 304 may include a mapping engine 306, a calculation engine 308, an allocation engine 310, and a report engine 312. The engines 306-312 may be executable by the one or more processors 302 to perform various operations. Additionally, any of the functions or operations described herein with respect to the engines 306-312, or with respect to the computing devices 106 generally, may be performed at least partially manually by the users 104.

The mapping engine 306 may assist in collecting, receiving, and/or processing information 108 associated with the entity 110. In one example, the mapping engine 306 may be configured to collect, store, process, organize, correlate, and/or access any of the information 108 described herein. For example, the mapping engine 306 may be configured to receive such information 108, including any of the categories 204 and data entries 206 described above. Additionally, the mapping engine 306 may be configured to receive additional information 108 that is not pre-formatted with such categories 204. Such information may include, for example, any of the rules, transfer pricing classifications, earnings targets, entity-specific policies, and/or other like information 108. Upon receiving such information 108 from a variety of different sources, the mapping engine 306 may be configured to transfer such information 108 to an information data store 314 of the memory 304 for storage therein. For example, the mapping engine 306 may be configured to group, sort, and/or otherwise categorize such information 108, and to store such categorized information 108 in the information data store 314. By categorizing such information 108 and/or storing such categorized information 108, the information 108 may be retrieved by the various engines 306-312 in a relatively streamlined fashion. Additionally, the mapping engine 306 may transfer any of the rules, transfer pricing classifications, earnings targets, entity-specific policies, and/or other like information 108 to a policy data store 316 of the memory 304 for storage therein. It is understood that the categorization and/or storage functions of the mapping engine 306 may be performed automatically or at least partially manually in various embodiments of the present disclosure.

The mapping engine 306 may also be configured to generate the supply chain map 210, described above with respect to FIG. 2, based on the gathered information 108. During this process, the mapping engine 306 may identify the sales division, manufacturing division, supplier division, and/or other divisions of the entity 110 from the information 108. The mapping engine 306 may also evaluate the information 108, and may generate the supply chain map 210 in response to such an evaluation. For example, in an embodiment of the present disclosure such information 108 may be gathered from several different sources. For instance, financial information 202 may be gathered from one or more databases of the entity 110 wherein trial balances are stored. Additional analogous financial information 202 may also be gathered from accounting systems and/or other (i.e., secondary) sources from within the entity 110. In such an embodiment, the mapping engine 306 may confirm that the respective data entries 206 gathered from the first source match corresponding data entries 206 of the additional information gathered from the secondary sources within the entity 110. Once the mapping engine 306 has confirmed that the respective data entries 206 match, the mapping engine 306 may generate a corresponding supply chain map 210 in response.

In generating the supply chain map 210, the mapping engine 306 may also assign one or more transfer pricing classifications to the intra-entity transactions performed by each division of the entity 110. As noted above, such transfer pricing classifications may include, for example, an indication of currency and an exchange rate associated with the respective transactions. In this way, the mapping engine 306 may generate a supply chain map 210 that reflects the transfer pricing methodology, rules, and/or policies specific to the entity 110 in question. Once generated, the supply chain map 210 may be transferred by the mapping engine 306 to an output data store 318 for storage therein.

The calculation engine 308 may be configured to identify the one or more functions performed by each division of the entity 110, and to determine, for each respective function, an allocation relationship based on one or more operating parameters of the respective division. Such relationships may, for example, take into account the rules, target earnings, and/or policies specific to the entity 110. For example, based on the information 108 described above with respect to Zoom Motors, the calculation engine 308 may determine that the manufacturing division Zoom Spain performs manufacturing, distribution, and sales functions during the intra-entity sales of its products to Zoom UK. With such functions identified, the calculation engine 308 may derive and/or otherwise determine, for example, one or more percentages, ratios, algorithms, equations, and/or other like allocation relationships associated with each respective function, and such derived allocation relationships may be based on, for example, headcount, net revenue, and/or other like operating parameters of Zoom Spain. In example embodiments, the operating parameter utilized by the calculation engine 308 in determining such allocation relationships may be specified by the entity 110 and/or maybe included in the gathered information 108.

For example, utilizing headcount as an operating parameter, if it is known from the gathered information 108 that 100 employees 116 work for Zoom Spain, and that 80 of the employees 116, are primarily involved in manufacturing tasks, 10 of the employees 116 are primarily involved in distribution tasks, and the remaining 10 employees 116 are primarily involved in sales tasks, the calculation engine 308 may generate a respective allocation relationship for the manufacturing, distribution, and sales functions performed by Zoom Spain based on the above headcount. In the above example, the calculation engine 308 may assign an 80% allocation relationship to the manufacturing function performed by Zoom Spain, a 10% allocation relationship to the distribution function, and a 10% allocation relationship to the sales function. Based on these relationships, selling expenses associated with the various intra-entity transactions performed by Zoom Spain can be allocated to each respective function performed by Zoom Spain during such transactions. In an example embodiment, the calculation engine 308 may transfer such allocation relationships to the output data store 318 for storage therein.

The allocation engine 310 may be configured to correlate and/or otherwise map the various expenses incurred by each of the divisions of the entity 110 to the different functions performed by the respective divisions. As a result, the allocation engine 310 may determine sales expenses for each function performed by the respective division of the entity 110, and such sales expenses may be derived using the respective allocation relationships determined by the calculation engine 308. For example, if it is known from the collected information 108 that the net intra-entity transaction expenses for Zoom-Spain are equal to $200 million, the allocation engine 310 may allocate these net expenses among the manufacturing, distribution, and sales functions described above with respect to the calculation engine 308. In such an example, the allocation engine 310 may determine the respective sales expense associated with each of these functions by multiplying and/or otherwise processing the known $200 million in net sales expenses in accordance with the respective allocation relationships. As a result, the allocation engine 310 may determine that the sales expense associated with the manufacturing function of Zoom Spain is equal to $160 million, the sales expense associated with the distribution function is $20 million, and the sales expense associated with the sales function is $20 million. Such sales expenses may be transferred by the calculation engine 308 to the output data store 318 for storage therein.

The calculation engine 308 may also be configured to determine the net income associated with each function performed by the various respective divisions of the entity 110 based on the respective sales expense corresponding to each function. For example, if it is known from the gathered information 108 that Zoom Spain has a gross income equal to $800 million, the calculation engine 308 may determine the net income associated with each function performed by Zoom Spain by multiplying the known gross income described above by the allocation relationships for each of the respective functions and deducting the respective sales expense noted above. Thus, in such an example, the net income associated with the manufacturing function performed by Zoom Spain may be equal to $480 million, the net income associated with the distribution function may be equal to $60 million, and the net income associated with the sales function may be equal to $60 million. The calculation engine 308 may transfer such respective net income to the output data store 318 for storage therein.

The report engine 312 may be configured to facilitate monitoring of the net income of the various divisions of the entity 110, on a function-by-function basis. For example, the report engine 312 may be configured to provide an indication of net income and target earnings to the entity 110, for each respective division of the entity 110, and on a function by function basis. For instance, in the Zoom Spain example described above, the report engine 312 may generate a report indicating the manufacturing function net income of $480 million, the distribution function net income of $60 million, and the sales function net income of $60 million. Such a report may also indicate and/or compare net income to known target earnings for Zoom Spain corresponding to the above functions. For example, based on the collected information 108, it may be known that the target earnings for the manufacturing function may be $500 million, the target earnings for the distribution function may be $80 million, and the target earnings for the sales function may be $80 million. In such an example, the net income for each of the above functions performed by Zoom Spain may have fallen short of their corresponding target earnings by $20 million. Accordingly, the report generated by the report engine 312 may provide such a comparison and may also provide a “true-up” value associated with the net income and target earnings of each respective function. In such an example, the true-up value may be indicative of a difference between the net income and the target earnings. For instance, in the example described above the respective true-up values associated with the target earnings for the manufacturing, distribution, and sales functions performed by Zoom Spain may each be equal to $20 million. Files, reports, and/or other outputs of the report engine 312 may be transferred by the report engine 312 to the output data store for storage therein.

In various embodiments, one or more of the engines 306-312 of the memory 304 may be implemented entirely or in part on computing device 106 of the user 104 or on server 112 of the entity 110 that is remote from the computing device 106 of the user 104. For example, in some embodiments, the mapping engine 306, calculation engine 308, and/or the allocation engine 310 may be implemented on one or more servers 112 and provided as a web service to computing devices 106 of the users 104. In such an embodiment, the users 104 may access the mapping engine 306, calculation engine 308, and/or the allocation engine 310 through web browsers. In other embodiments, one or more of the engines 306-312 may be implemented at least partially on the computing device 106 of the user 104. These embodiments are described simply for illustrative purposes, and any number of alternative dispositions of the engines 306-312 may be utilized.

With continued reference to FIG. 3, in various embodiments the memory 304 is volatile (such as RAM), non-volatile (such as ROM, flash memory, etc.) or some combination of the two. While FIG. 3 illustrates the engines 306-312 and data stores 314-318 being stored on a single computing device 106, it is to be understood that one or more of the engines 306-312 and/or data stores 314-318 may be distributed among multiple computing devices 106.

In some embodiments, the computing device 106 may also include additional data storage devices (removable and/or non-removable) such as, for example, magnetic disks, optical disks, or tape. Such additional storage is illustrated in FIG. 3 by removable storage 320 and non-removable storage 322. Computer-readable media may include volatile and nonvolatile, removable and non-removable media implemented in any method or technology for storage of information, such as computer readable instructions, data structures, program modules, or other data. Memory 304, removable storage 320 and non-removable storage 322 are all examples of non-transitory computer-readable media. Non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store information 108 and which can be accessed by the computing device 106. Any such non-transitory computer-readable media may be part of the computing device 106.

The computing device 106 may also include input device(s) 324, such as a keyboard, a mouse, a touch-sensitive display, voice input device, and/or any other known user interface device, in communication with the one or more processors 302. Such input devices 324 may be configured to collect and/or receive the information 108 from any of the various sources described herein. Additionally, the computing device 106 may include output device(s) 326 such as a display, speakers, a printer, etc. These devices are well known in the art and need not be discussed at length here.

The computing device 106 also contains communication connections 328 that allow the computing device 106 to communicate with other computing devices 330, such as device(s) implementing a financial platform or other like functionality.

### Example Process

FIG. 4 illustrates an example process. This process is illustrated as a logical flow graph 400, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process.

FIG. 4 illustrates an example process for determining the net income of an entity 110 based at least in part on transfer prices, and generating a report indicative of the net income and target earnings. It is understood that the net income determined by the example processes described herein may comprise an indication of the actual earnings of the entity 110, and that in some embodiments, retained earnings, total assets, total liabilities, and/or other like financial metrics may additionally or alternatively be determined by the example processes of the present disclosure. Additionally, any of the financial metrics described herein may be determined for each of the respective functions performed by the various divisions of the entity 110. Since the financial metrics described herein may be determined, for each respective function, based on various transfer pricing classifications associated with the intra-entity transactions of the respective divisions, the reports generated by the processes described herein may adequately satisfy the increasingly stringent transfer pricing rules associated with such transactions. It is understood that one or more of the operations described below with respect to FIG. 4 may be performed at least partially manually by one or more of the users 104.

In an example embodiment, the process includes, at 402, gathering, by one or more computing devices 106, information 108 associated with the entity 110. Such information 108 may include financial information 202 comprising categories 204, data entries 206, and/or any other like information typically included in and/or otherwise associated with the trial balances described herein. Such information 108 may also include operating information 208 associated with the entity 110 comprising rules, policies, target earnings, operating parameters, intra-entity agreements, product codes, profit centers, cost centers, level entity codes, hierarchies, organization charts, material codes, SKU numbers, trading partners, customers, and/or any other entity-specific information characteristic of the various supply chains, business practices, and/or other organizational operations of the entity 110. Such information 108 may further include tax information such as federal tax laws, state tax laws, tax formulas, tax calculation flows, tax rates, modification rates, graduated rates, payment options, tax adjustment options, tax credit options, calculating options, rounding options, filing methods, or tax forms. In some embodiments, one or more users 104 may gather the information 108 from various sources and manually enter the information 108 into the memory 304 of one or more computing devices 106. In other embodiments, the one or more computing devices 106 may automatically retrieve the information 108 from one or more sources. It is understood that the gathered information 108 may be associated with and/or otherwise characteristic of the various divisions of the entity 110.

At 404, the one or more computing devices 106 may generate a supply chain map 210 based on the gathered information 108. In generating such a supply chain map 210, a computing device 106 may, at 406, identify the respective sales divisions, manufacturing divisions, supplier divisions, and/or other operational divisions of the entity 110. The resulting supply chain map 210 may list, classify, categorize, and/or otherwise identify each of the divisions of the entity 110. In particular, the information 108 gathered at 402 may be sorted such that the information 108 may be included in the supply chain map 110 in association with at least one of the corresponding divisions of the entity 110.

Additionally, at 408, the computing device 106 may assign a transfer pricing classification to the various intra-entity transactions performed by each of the respective divisions. For example, the computing device 106 may assign a first transfer pricing classification to transactions between a supplier division of the entity 110 and a manufacturing division of the entity 110. The computing device 106 may also sign a second transfer pricing classification to transactions between the manufacturing division and a sales division of the entity 110. In such an example, the computing device 106 may determine intra-entity sales expenses associated with such transactions based on at least one of the first and second transfer pricing classifications assigned at 408. Further, in such embodiments, at least one of the first and second transfer pricing classifications may include an indication of currency and an exchange rate associated with the respective transactions.

Such transfer pricing classifications may also include, for example, tax rates and/or other like regulations associated with the various divisions of the entity 110. For example, the sales division of the entity 110 may be located in a first jurisdiction having a first tax structure, and at least one of the manufacturing division and the supplier division may be located in a second jurisdiction, different than the first jurisdiction, and having a second tax structure different than the first tax structure. In such an example, the computing device 106 may determine intra-entity sales expenses associated with transactions between the various divisions of the entity 110 based at least in part on the respective tax structures of the different jurisdictions.

Additionally, as noted above, the financial information, operating information, tax information, and/or other information 108 described herein may be gathered from one or more different sources associated with the entity 110. Such sources may include various databases, financial platforms, employees 116, and/or any of the other sources described above. Accordingly, generating the supply chain map 210 at 404 may also include confirming that the respective categories and/or data entries gathered from a first source match the corresponding categories and/or data entries gathered from a second source different than the first source. In such an example, the computing device 106 may generate the supply chain map 210 in response to confirming that the respective categories and/or data entries gathered from the first source match the corresponding categories and/or data entries gathered from the second source.

At 410, the computing device 106 may identify a plurality of functions performed by at least one of the sales division, manufacturing division, and/or supplier division of the entity 110 based on the information 108. In an example embodiment, such functions may be performed by the respective divisions during and intra-entity transaction by at least one of the identified divisions. Additionally, the functions identified at 410 may include one or more of sales, distribution, entrepreneurship, manufacturing, administrative duties, and/or other functions typically performed by divisions of an entity 110.

At 412, the computing device 106 may determine, for each of the functions identified at 410, an allocation relationship based on one or more operating parameters of an associated division. As noted above, such operating parameters may be specified by the entity 110 as a basis for the functional allocations described herein. In exemplary embodiments, such operating parameters may include, for example, headcount, net revenue, and/or other financial or operational metrics commonly tracked by the entity 110. It is understood that such operating parameters may include one or more of the categories and/or data entries of the information 108 gathered at 402. In an example embodiment, the allocation relationships determined at 412 may include one or more ratios, percentages, algorithms, or other known relationship useful in associating, correlating, and/or otherwise allocating costs or expenses of the various divisions to the various functions performed by such divisions.

At 414, the computing device 106 may determine, for each function, an intra-entity sales expense using the respective allocation relationship associated with each function identified at 410. For example, based on a known net intra-entity sales expense for one of the divisions, the computing device 106 may allocate a portion of such a known expense to each of the functions performed by the division. The allocation may be performed using, for example, the one or more ratios or other allocation relationships determined at 412.

Once the respective sales expenses have been determined at 414, the computing device 106 may determine, at 416, a net income associated with each respective function, based on the respective sales expenses determined at 414. Such a determination may be made by, for example, allocating a known gross profits, gross income, and/or other like accounting metric between the various functions performed by a division of the entity 110. Once such a known gross metric has been allocated, the computing device 106 may deduct the sales expenses determined that 414 from each of the allocated metrics.

At 418, the computing device may provide the entity 110 with an indication of the net income determined at 416. For example, the computing device 106 may provide the entity 110 with an indication of net income and target earnings for a particular division of the entity 110, and one or both of the net income and the target earnings may be provided to the entity 110 for each respective function (i.e., on a function-by-function basis). In an example embodiment, the computing device 106 may generate a report at 420 identifying the net income and target earnings of the division, and such metrics may be provided in the report for each respective function performed by the division. Additionally, at 422, the computing device 106 may determine a true-up value indicative of a difference between the net income and the target earnings, for each function. In such embodiments, the report generated at 420 may include the net income, the target earnings, and the true up value for each function. By including such a comparison in the report, the entity 110 may be able to easily determine situations in which transfer pricing classifications, internal policies, target earning levels, and/or other operations of the entity 110 may need to be modified in order to comply with applicable tax rules, regulations, and/or transfer pricing requirements. The report generated at 420 may also be sufficient for satisfying the reporting and justification requirements of known and future transfer pricing regulations.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method, comprising:
identifying a plurality of functions performed by at least one of a sales division of an entity, a manufacturing division of the entity, or a supplier division of the entity during an intra-entity transaction by the at least one division;
determining, for each function of the plurality of functions, an allocation relationship based on an operating parameter of the at least one division;
determining, for each function, an intra-entity sales expense using the respective allocation relationship associated with each function; and
providing, to the entity, an indication of net income and target earnings for the at least one division,
wherein the net income is provided for each function, and wherein the net income is determined based on the respective intra-entity sales expense associated with each function.

2. The method of claim 1, further comprising assigning a first transfer pricing classification to transactions between the supplier division and the manufacturing division;
assigning a second transfer pricing classification to transactions between the manufacturing division and the sales division; and
determining the intra-entity sales expense, for each function, based on at least one of the first and second transfer pricing classifications.

3. The method of claim 2, wherein at least one of the first and second transfer pricing classifications comprises an indication of currency and an exchange rate associated with the respective transactions.

4. The method of claim 1, wherein the sales division of the entity is located in a first jurisdiction having a first tax structure, and at least one of the manufacturing division and the supplier division is located in a second jurisdiction different than the first jurisdiction, the second jurisdiction having a second tax structure different than the first tax structure.

5. The method of claim 1, wherein providing the indication of net income and target earnings for the at least one division comprises generating a report including the net income, the target earnings, and a true-up value indicative of a difference between the net income and the target earnings.

6. The method of claim 1, further comprising gathering, from a first source, information associated with the entity, wherein the information includes a plurality of categories and respective data entries corresponding to each category of the plurality of categories; and
generating a supply chain map based on the information, wherein the supply chain map identifies the sales division, the manufacturing division, and the supplier division.

7. The method of claim 6, wherein the operating parameter comprises a category of the first plurality of categories.

8. The method of claim 6, wherein the information comprises at least one of financial information or operating information, and wherein the information is characteristic of the sales division, the manufacturing division, or the supplier division.

9. The method of claim 6, wherein the first source comprises a database, the method further comprising gathering additional information associated with the entity from a second source different than the first source.

10. The method of claim 9, wherein the additional information is gathered via in-person communication with an employee of the entity.

11. The method of claim 9, further comprising confirming that the respective data entries gathered from the first source match corresponding data entries of the additional information gathered from the second source; and
generating the supply chain map in response to confirming that the respective data entries gathered from the first source match the corresponding data entries of the additional information.

12. The method of claim 6, wherein the plurality of categories comprises at least one of a product code, the sales division of the entity, the manufacturing division of the entity, the supplier division of the entity, a head count, a net revenue, a material code, a trade partner, an asset, a liability, a currency, an exchange rate, a target earning level, and a level entity code.

13. One or more non-transitory computer-readable media having stored thereon computer programming instructions which, when executed by a processor, cause a computing device to perform operations, comprising:
receiving, from a first source, information indicative of a sales division of an entity, a manufacturing division of the entity, and a supplier division of the entity;
identifying a plurality of functions performed by at least one of the sales division, the manufacturing division, or the supplier division during an intra-entity transaction by the at least one division;
determining, for each function of the plurality of functions, an allocation relationship based on an operating parameter of the at least one division;
determining, for each function, an intra-entity sales expense using the respective allocation relationship associated with each function; and
providing, to the entity, an indication of net income and target earnings for the at least one division,
wherein the net income is provided for each function, and wherein the net income is determined based on the respective intra-entity sales expense associated with each function.

14. The non-transitory one or more computer-readable media of claim 13, the operations further comprising assigning a first transfer pricing classification to transactions between the supplier division and the manufacturing division;
assigning a second transfer pricing classification to transactions between the manufacturing division and the sales division; and
determining the intra-entity sales expense, for each function, based on at least one of the first and second transfer pricing classifications.

15. The non-transitory one or more computer-readable media of claim 13, wherein providing the indication of net income and target earnings for the at least one division comprises generating a report including the net income, the target earnings, and a true-up value indicative of a difference between the net income and the target earnings.

16. The one or more non-transitory computer-readable media of claim 13, wherein the information comprises at least one of financial information or operating information characteristic of the sales division, the manufacturing division, or the supplier division, the operations further comprising generating a supply chain map based on the information,
wherein the supply chain map identifies the sales division, the manufacturing division, and the supplier division.

17. A system, comprising:
one or more processors;
an input device in communication with the one or more processors and configured to receive information indicative of a sales division of an entity, a manufacturing division of the entity, and a supplier division of the entity; and
a calculation engine, a mapping engine, and an allocation engine in communication with the one or more processors, wherein, when executed by the one or more processors,
the mapping engine identifies a plurality of functions performed by at least one of the sales division, the manufacturing division, or the supplier division during an intra-entity transaction by the at least one division;
the calculation engine determines, for each function of the plurality of functions, an allocation relationship based on an operating parameter of the at least one division; and
the allocation engine determines, for each function, an intra-entity sales expense using the respective allocation relationship associated with each function.

18. The system of claim 17, further comprising a report engine in communication with the one or more processors,
wherein, when executed by the one or more processors, the report engine provides, to the entity, an indication of net income and target earnings for the at least one division, wherein the net income is provided, for each function, based on the respective intra-entity sales expense determined for each function.

19. The system of claim 17, further comprising at least one data store in communication with the input device and at least one of the mapping engine, the calculation engine, and the allocation engine, the at least one data store configured to store the received information,
wherein the information comprises at least one of financial information or operating information, and
wherein the information is characteristic of the sales division, the manufacturing division, or the supplier division.

20. The system of claim 17, wherein, when executed by the one or more processors, the mapping engine generates a supply chain map based on the information, wherein the supply chain map identifies the sales division, the manufacturing division, and the supplier division.
